(19) United States
(12) Patent Application Publication
(10) Pub. No.: US 2003/0145022 A1
(43) Pub. Date: Jul. 31, 2003

(54) Storage and management of semi-structured data

(75) Inventor: Andrew Peter Dingley, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/303,137

(22) Filed: Nov. 21, 2002

(30) Foreign Application Priority Data
Jan. 31, 2002 (GB) 0202178.0

(51) Int. Cl. G06F 12/00

(52) U.S. Cl. 707/204

(57) ABSTRACT

Data having a desirable and machine readable structure, but which is not known in advance may be thought of as semi-structured data. Semi-structured data may be represented in Resource Document Framwork (RDF) format, and such documents may be parsed to form a table of triples. Relatively small amounts of data give rise to substantial number of triples, meaning that a triple store for relatively small amounts of data will have relatively large number of rows. A management programme for a triple store monitors the number of occasions on which a given query is executed, and if the frequency of the query exceeds a given threshold, then the triples forming the result set of the query are migrated to an auxiliary triple store, thus reducing the number of rows searchable as a result of execution of the given query.

### BACKGROUND TO THE INVENTION

1. Field of the Invention

The present invention relates to the storage of semi-structured data, for example in a database, and to the management of such data storage.

2. Description of Related Art

A database typically contains a plurality of records, and may be thought of as tabular in architecture, with each row of the table relating to a different record, and each attribute of a record, such as “name” or “date of birth” for example being stored in a different column of a row. Traditionally databases have been used to store what may be termed structured data. That is to say that, for example each column of the table is designated specifically for the storage of a particular attribute. Thus for example, where, in a database which stores personal details of employees, a column is designated for the storage of “date of birth” data, all entries in that column will relate only to date of birth. This ostensibly self-evident database architecture works well where the nature of the data being stored may be defined accurately prior to configuration of the system, and where any changes to the nature of the attributes of a record are pre-notified, thereby enabling the database to be reconfigured to take account of them, for example either by re-designation of one or more existing columns to provide for the storage of changed attributes.

However such inflexibility is regarded as a significant handicap to the easy maintenance of contemporary records, and is wholly inappropriate in circumstances where it is not possible to define accurately in advance the attributes of the data to be stored, or where these may change frequently and/or without prior notice. Data whose attributes may change in this way may be termed semi-structured data. Semi-structured data thus has a describable and machine-processable structure, but this structure may not be known in advance. It is possible to represent semi-structured data using a data model known as Resource Description Framework (RDF), which represents data in the form of a mathematical graph, that is to say a graph of nodes and directed arcs, and in doing so illustrates any interrelationship of different attributes, whether between attributes of the same record, or attributes of a different record. In accordance with the terminology of the RDF data model, data is represented either as a Resource, a Property, or a Value. It is possible to deconstruct, or “parse” the RDF graphical representation of data into tabular form, where the table has three columns: subject, verb, object, corresponding to Resource, Property and Value. The parsing and subsequent storage of records is performed in such a manner that no data is lost. Thus it is possible to reconstruct the RDF graphical representation from the information present in the table, i.e. the data within the table, together with the column or row in which the data is stored. Records which are stored as “Subject, Verb, Object” are known in the art as “triples”, and complete parsing (i.e. so that all the information within the RDF document is transferred into the resulting table of triples) of an RDF document of any size results in a relatively large table (i.e. having many rows) of triples. Consequently, searching a given column for a given attribute is likely to take a substantial amount of time as a result of the relatively large number of rows in the table.

### SUMMARY OF THE INVENTION

A first aspect of the present invention relates to the management of a store of triples in order to ameliorate the problem of searching large numbers of rows of a triple store on each occasion a search query is executed. Accordingly, a first aspect of the present invention provides a database having a principal table of triples, and a management programme adapted to monitor operation of the principal table and to migrate triples from the principal table to one or more auxiliary tables when at least one criterion tested by the programme is met.

In migrating triples to an auxiliary table, which may already exist, or may have been created especially for the purpose of accommodating the migrating triples, the management programme is reducing the number of rows which have to be searched in order to execute a query whose result set includes the migrated triples, since the size, i.e. the number of rows, of the table in which the migrated triples are stored will typically be smaller than the principal table.

In one embodiment the management programme migrates triples on the basis of the frequency individual sets of triples (a set containing any number of triples from, and including zero, upwards) are accessed as a result of a query being executed. In a further embodiment, the management programme operates on the basis of the frequency of particular queries, for example migrating triples which are the result set to frequent queries.

The frequency with which sets of triples are accessed may be determined in a number of ways, for example in one embodiment it may be calculated as a proportion of the queries for the triple store as a whole over the course of an interval determined by a preset number of queries. Alternatively, it may be determined with reference simply to the passage of time.

Other criteria, either alone or in conjunction may be applied to determine whether triples are to be migrated.

Preferably the management programme also operates continually to monitor auxiliary tables, and to repatriate sets of triples to the principal table when one or more of the criterion tested by the programme fail to be met, thus for example, removing an unnecessary overhead of maintaining an auxiliary table containing triples which are never accessed during execution of a search query. Typically, the same criterion or criteria are tested for determining whether migration and repatriation ought to take place.

### BRIEF DESCRIPTION OF DRAWINGS

An embodiment of the invention will now be described, by way of example, and with reference to the accompanying drawings in which:

FIG. 1 shows two conventional database entries;

FIG. 2 shows the representation of the data forming the entries of FIG. 1 in Resource Document Format (RDF);

FIG. 3 is a triple store resulting from the complete parsing of the RDF document of FIG. 2;

FIG. 4 is a flowchart illustrating the operation of a database management programme, used for example with the triple store of FIG. 3.

### DESCRIPTION OF PREFERRED EMBODIMENTS

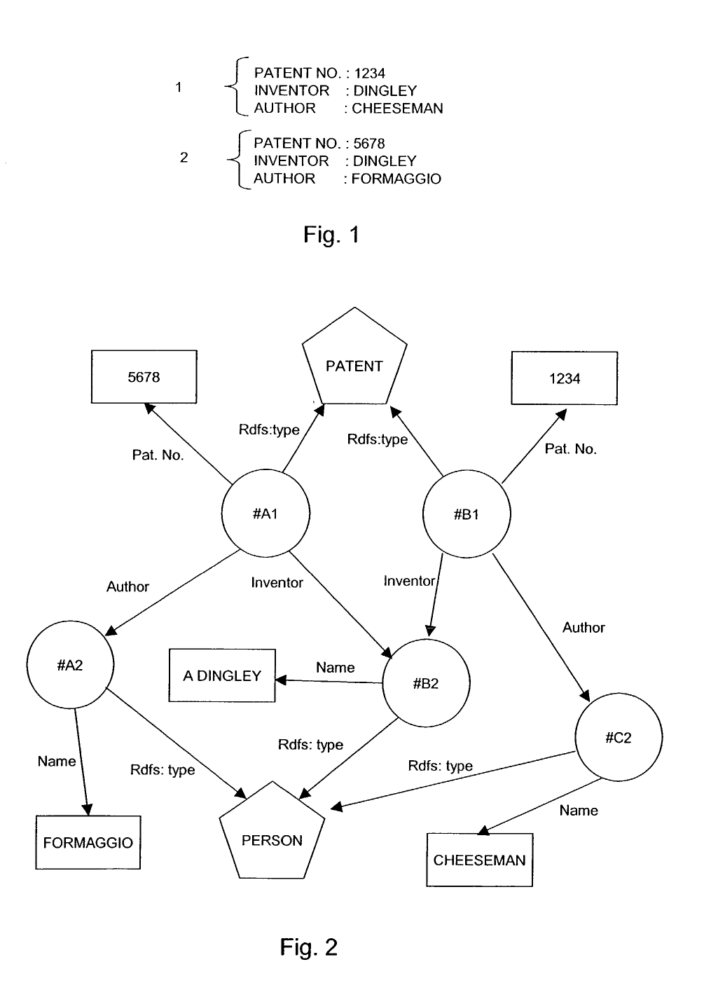

Referring now to FIG. 1, two records whose data it is desired to store in a database are illustrated. Each record has three attributes: the publication number of a patent, the inventor designated on the patent, and the author of the specification of the patent. As can be seen from looking at the records, the inventor in each case is the same, and so to this extent at least, the two records are interrelated.

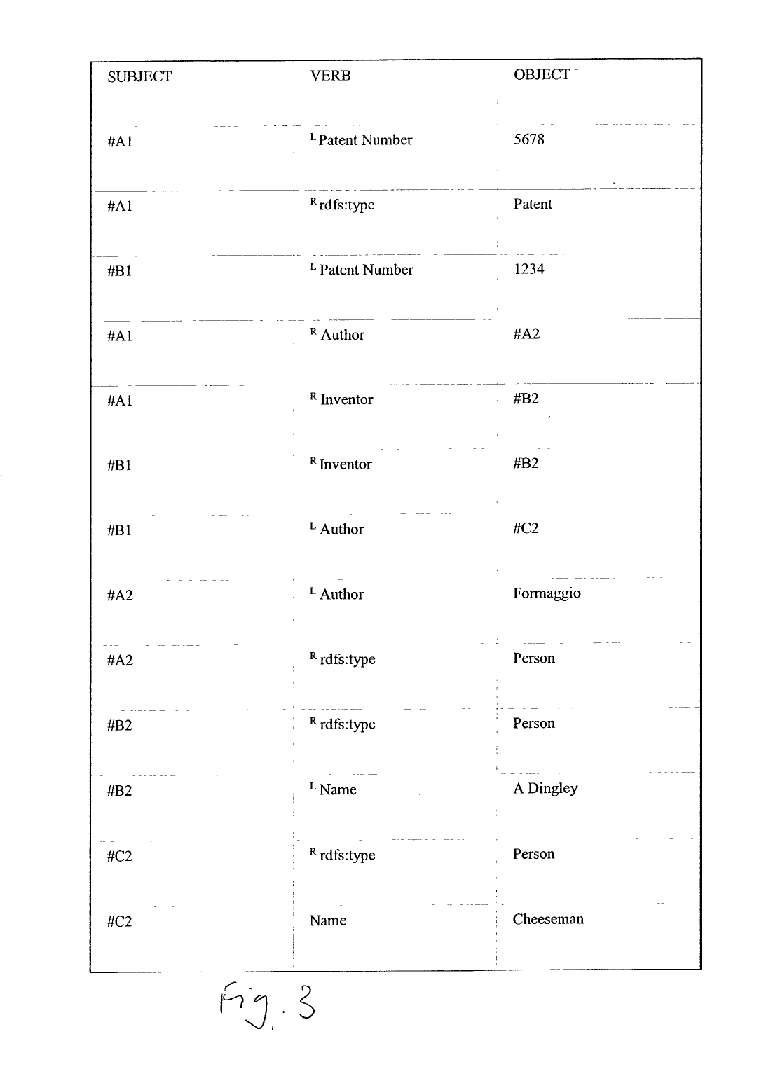

Referring now to FIG. 2, both records, and their interrelationship can be represented in a graphical document format known as Resource Description Framework (RDF), and an RDF document representative of the two records is shown in FIG. 2. The RDF document may be thought of as graphical representation of the data in FIG. 1, which also describes the structure of that data, and contains essentially three elements: Resources, Properties and Values. Thus for example, the document in FIG. 2 has a resource #A1. This Resource is labelled #A1, although in the event that the resource could be named by a Uniform Resource Indicator (URI), such as for example a web page address, this would also appear in the name of the Resource. In this example the resource has no such name, but has four different properties which, inter alia serve to characterise it: Pat. No., Author, Inventor (all of which may intuitively be related to one of the records in FIG. 1), and “rdf: type”. The first three properties are simply the different attributes of one of the records shown in FIG. 1, while the fourth indicates the type or nature of the Resource, which in this instance is a patent. With this in mind it follows that a patent (which is the “type” of the Resource) has the properties of Author, Inventor and Number, and while this may not be the most intuitive way to describe a record in FIG. 1 from a lay person's perspective, it nonetheless is possible to see that all of the information shown in a record in FIG. 1 is replicated in this format. Thus the two Resources #A1 and #B1 relate to the patents 5678 and 1234 respectively.

The properties of Inventor and Author for each of these two Resources are respectively represented by further Resources: #B2 which corresponds to the inventor—since the inventor is the same in each case; and #A2 and #C2 which correspond to the two authors. The Resource #B2 is thus the Value of the Inventor Property for each of the Resources #A1 and #B 1, and itself has two further properties, one of which is its rdfs: type, indicating that the Inventor is a person, and the other is the name of the inventor, which is its “literal” Value, the inventor's name A. Dingley. The Author Properties of the Resources #A1 and #B1 are respectively the Resources #A2 and #B2 and each have an rdfs: type property which signifies that the Author is a person, and Name Properties having literal Values, which are the names of the Authors “Formaggio” and “Cheeseman” respectively.

Thus an RDF document describes completely both the data in a record, its nature and any interrelationship with data in another record. The purpose of representing data in such a manner is essentially to provide a common format independent of the source format of data, which may be manipulated by computers, and which contains all of the original data.

In order to store data having the form of an RDF document, it must be converted into a tabular form, and this is achieved by a process known in the art as parsing, which in this example is the analysis of the RDF document to yield a table of what are known as “triples”. A triple may be thought of as being the smallest part of the RDF document illustrated in FIG. 2 which has any meaning in isolation (i.e. an “atomic” part of an RDF document). Thus for example the Value “1234” is essentially meaningless on its own; it only starts to take on some meaning when it exists within a context which indicates that it is the Publication Number of a particular Resource; this is an example of a triple.

The RDF document of FIG. 2 is parsed to generate triples in a tabular form by considering the various elements of the document and their interrelationship as either “Subject”, “Verb” or “Object”, corresponding generally to Resource, Property and Value. Thus referring now to FIG. 3, the table of triples generated from the complete parsing of the RDF document of FIG. 2 is shown, and it can be seen that the first triple has a Subject #A1, the Verb Publn. No., and the Object 1234, corresponding to the Resource, Property and Value from the RDF document of FIG. 2. The category of the Verb in a given column, that is to say whether the property in the Verb points to a Subject which is a literal Value, or a Value which is a Resource, is also indicated within the Verb column with an appropriate letter (i.e. “L” or “R”).

In total the table of FIG. 3 contains 13 triples, which are the result of the complete parsing of the RDF document of FIG. 1, which in turn is generated from merely two database entries each of which has only three attributes. It is thus apparent that relatively small amounts of data may result in the creation of a relatively large triple store when the data is represented as an RDF document. One of the premises underlying the use of RDF is that the inevitable increase in the amount of data as a consequence of converting data into RDF is offset by the advantages gained from representing data in a standard form (assuming of course that RDF is a format which becomes widely adopted), and the increased flexibility which operating on data in RDF offers. Another premise is that the advances in computing power and memory may be used to deal with the additional data arising from the adoption of RDF.

However, it remains the case that, in order to execute a query on a triple store, each row of a particular column of the triple store must be searched for attributes in that column which match the query. The length of the triple store is thus one of the principal determining factors in the time required to execute a query on such a store. One aspect of the present invention provides dynamic management of a triple store to migrate particular sets of triples (or “rows” in database theory nomenclature) into a separate store in the event that they are frequently accessed when a query is executed, and (if they are located in a separate store) re-migrate sets of triples back into the principal triple store when they cease to be accessed frequently. This means that frequently accessed triples are located in one or more separate tables having fewer rows, and on which queries may therefore be executed more rapidly. In addition this also removes triples from the principal store, thus improving performance there for the remaining triples.

In one embodiment of the invention the criterion for determining whether a given triple is migrated to a separate store is whether it is accessed to form a part of the result set to a query on a predetermined number of occasions over the course of either a predetermined period of time (i.e. determined in terms, for example of years, days, hours, minutes and seconds), or alternatively as a proportion of a predetermined number of queries performed on the database (whether their execution accesses the given triple or not).

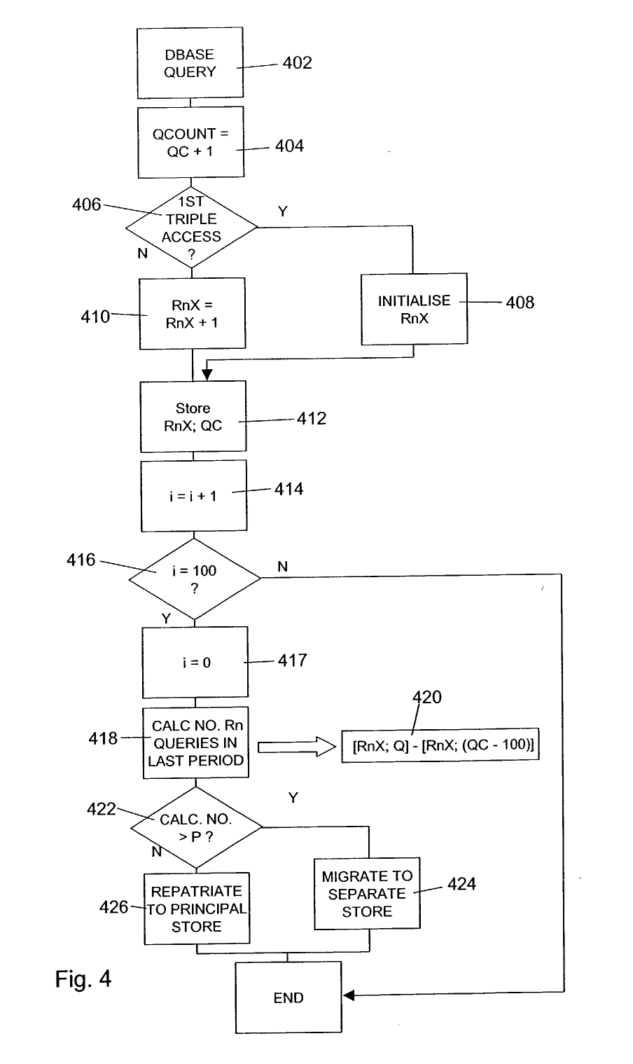

Referring now to FIG. 4, a database management programme operates to manage the triple store, and, where appropriate to migrate selected triples within the store into a separate store when the selected sets of triples are accessed frequently in the course of executing a query on the store. The programme's operation is effectively automatically invoked by the receipt of a query by the database at step 402, and receipt of the query causes, at step 404, the programme to augment a variable QCOUNT, representative of the total number of queries made of the triple store, by one. At step 406 the programme determines, for each triple forming part of the result set of the query, whether it has been accessed pursuant to a query before. If this is the first time the triple has been accessed, then a variable RnX is initialised with a value of one at step 408. The variable RnX is simply an an identifier for the triple which is unique within the database, which in this example is the row number of the triple (Rn), together with the number of times (X) the triple Rn has been accessed. If the triple has been accessed before, then the variable RnX will already be initialised, and is augmented by one at step 410. At step 412, the variable RnX is then stored, in conjunction with the value QC. These two variables denote the same event, i.e. a given query of the triple store, but with reference to different things: the variable QC is refers to the total number of queries, and so each value of QC is unique within the database, while the variable RnX denotes the Xth occasion on which row n of the database has been accessed. In combination, these two variables enable an evaluation of the frequency with which row n of the database is accessed in the course of a given number of queries of the triple store as a whole, or put another way, the proportion of queries of the triple store as a whole which access nth row of the database. This may be measured for example by reference to the aggregate number of queries ever received by the database, or by reference to an interval defined by a set number of queries. In the present example, the frequency with which a given triple is accessed is measured as a proportion of a given interval of 100 queries which accessed that triple. At step 414 a variable i, representing the total number of queries within the current interval of 100 queries, is augmented by 1, and at step 416 a decision is taken as to whether the interval total of 100 queries for the database as a whole has been reached. If it has, i is reset to zero at step 417, to restart the count, and then a calculation is performed at step 418 for each set of triples accessed over the course of the most recent interval to determine how often it has been accessed in this interval. This calculation is shown in box 420, and is simply the difference between the number of occasions on which the triple Rn was part of the result set to a query when the total number of queries (of the triple store as a whole) is (QC), and again when the total number of queries is (QC-100). A decision is then taken at step 422 to determine whether the number of occasions the triple has been accessed during the interval exceeds the predetermined number set as the threshold for migrating the triple into a separate store. If it has, the triple in question then is denoted as a candidate for migration to a separate store, and at step 424 the triple is migrated. Conversely, if the threshold is not exceeded, then the triple is repatriated at step 426 to the principal table if in a separate store, or not migrated if already in the principal store.

It should be noted that the steps of measuring, deciding, then migrating, may be performed by separate processes. Their description here as part of one process is not essential, but is useful for convenience in describing them. Slow processes such as migration may also be delayed or deferred until times of low system load. It is also possible to switch off monitoring for periods of extremely high load.

In a programme such as the one illustrated herein, in which management of the triple store is performed principally on the basis of the frequency of accessing a triple, a difficulty exists in deciding on an appropriate destination for migrating triples. In its simplest form the present invention provides simply that all sets of triples which, over the course of the previous 100 queries of the triple store as a whole, were accessed more than a predetermined number of occasions (“threshold access frequency”) are migrated to a single separate store. However, further improvements in this approach include, in one embodiment providing a plurality of separate stores for sets of triples having different access frequencies, with the number of triples in each separate store being determined by the access frequency of the triples in that store. Thus for example a store with triples with a high access frequency has a maximum of only a few triples, whereas a store with triples having a relatively low access frequency, but still in excess of the threshold will have a relatively large number of triples. In addition, the management programme preferably groups the triples for migration so that, where possible, triples are stored with other triples having a common subject, verb or object.

Alternatively, triples migrated from the triple store are grouped by reference to rdf type; either of the migrated triples, or possibly by reference to the rdf type of their parent, or even grandparent.

In a modification of the programme illustrated and described above, the management programme operates by using queries of the triple store to identify triples to be migrated. Thus in accordance with this modification the number of occasions a given query is executed is recorded, and in the event that the frequency of the given query exceeds a predetermined threshold, the sets of triples which form the result set to this given query are migrated to a separate store. This approach has the advantage of more straightforward migration and management of triples, since the process of identifying the triples to be migrated inherently groups them together for storage into a new store.

The dynamic management exemplified in the examples described above is particularly beneficial when storing semi-structured data, since documents in RDF format may be used to represent all manner of data. It is thus quite possible that upon addition of further triples to the triple store, subsequent to further parsing of an amended document, for example, the Verbs of the newly resultant triples may be Verbs not previously stored and whose triples are accessed more frequently than triples previously stored. In such a circumstance, it would make sense to migrate such new triples to an auxiliary table, which the present invention enables.

In a further modification, repatriation of a triple to the principal store is determined on the basis of one or more criteria which differ from the or each criterion used to determine whether the triple should be migrated. Thus for example, the management programme may be configured to include some in-built inertia against repatriation once migration has occurred. For example, in the case where both migration and repatriation are determined on the basis of a proportion of queries which access them, the programme may be configured so that once migrated, a query accessing a triple must fail to be executed the requisite number of times, for example, on two intervals of 100 queries of the database as a whole before being repatriated. Alternatively, an entirely different criterion may be used to determine repatriation, so that, for example the proportion of queries is monitored to determine whether migration ought to take place, whereas the number of occasions a migrated triple is accessed is monitored to determine whether repatriation takes place. Typically repatriation is likely to be less frequent than migration, and in one embodiment repatriation may simply not be possible.

1. A database having a principal table of triples, and a management programme adapted to monitor operation of the principal table and migrate triples from the principal table to at least one newly-generated auxiliary table when at least one criterion tested by the programme is met.

2. A database according to claim 1 wherein the management programme is additionally adapted to monitor operation of an auxiliary table and to repatriate one or more triples from the monitored auxiliary table to the principal table in the event at least one criterion tested by the programme is not met.

3. A database according to claim 2 wherein the programme is adapted to test the same at least one criterion in determining whether a triple is to be migrated to an auxiliary table and in determining whether a triple is to be repatriated to the principal table from an auxiliary table.

4. A database according to claim 2 wherein the programme is adapted to test different criteria in determining whether a triple is to be migrated to an auxiliary table and in determining whether a triple is to be repatriated to the principal table from an auxiliary table.

5. A database according to claim 1 wherein the management programme is adapted to test the number of occasions on which a triple is accessed as a result of execution of a query, as a proportion of a number of queries received by the database as a whole.

6. A database according to claim 6 wherein the management programme is adapted to test the number of occasions on which a triple is accessed as a result of execution of a query, as a proportion of a predetermined number of queries received by the database as a whole.

7. A database according to claim 1 wherein the management programme is adapted to test the number of occasions on which a triple is accessed as a result of execution of a query within a given period of time.

8. A database according to claim 1 wherein the management programme is adapted to test the number of occasions a given query is executed as a proportion of all queries executed.

9. A database according to claim 8 wherein the management programme is adapted to test the number of occasions a given query is executed during the course of execution of a predetermined total number of queries executed.

10. A database according to claim 1 wherein the management programme is adapted to test the number of occasions on which a given query is executed within predetermined period of time.

11. A database according to claim 8 wherein, in the event the at least one criterion tested by the management programme is met, all triples forming the result set to a given query are migrated to an auxiliary table.

12. A database according to claim 1, wherein migrated triples of the same rdf type are migrated to a common auxiliary table.
